(19) United States
(12) Patent Application Publication
(10) Pub. No.: US 2023/0371754 A1
(43) Pub. Date: Nov. 23, 2023

(54) MIX-IN TOOL FOR PROCESSED FOOD

(71) Applicant: SharkNinja Operating LLC, Needham, MA (US)

(72) Inventors: Lukas Tubby, Mansfield, MA (US); Eric Holzer, Natick, MA (US)

(73) Assignee: SharkNinja Operating LLC, Needham, MA (US)

(21) Appl. No.: 17/749,611

(22) Filed: May 20, 2022

(51) Int. Cl. A47J 43/28; A23P 20/20

(52) U.S. Cl. CPC A47J 43/288; A23P 20/20

(57) ABSTRACT

Mix-in tools for use with processed food include two wing members defining a helical profile coupled to a central shaft attached to a handle. Inserting the wing members into the processed food and rotating the handle creates a central cavity in the processed for gently mixing in ingredients before additional processing. The wing members also include spatula-like, flat edged sides for cleaning out the processed food from a vessel.

### FIELD OF THE INVENTION

The present disclosure relates to a mixing tool and, more particularly, to a mixing tool for mixing ingredients into processed foods, such as ice cream.

### BACKGROUND

Consumers increasingly enjoy making home-made ice cream. During the ice cream making process, users often prefer to add in additional ingredients such as fruit, chocolate chips, and cookie pieces. In some cases, the user adds the ingredients while the ice cream is still churning. However, in other case, the user mixes in the ingredients just before the ice cream is finished. The user generally uses a spatula or spoon to gently fold the ingredients into the ice cream, which is especially important when handling delicate ingredients like fresh berries.

### SUMMARY

This disclosure describes, in some embodiments, a mix-in tool for use with processed food, such as ice cream, which may include two wing members defining a helical profile coupled to a central shaft attached to a handle. A user can insert the wing members into the ice cream and rotate the handle to create a central cavity in the ice cream for gently mixing in ingredients before additional processing. Advantageously, the wing members also may include spatula-like, flat-edged sides for cleaning out the ice cream from the processing vessel. The mix-in tool thus may allow for minimal ice cream waste and simplifies the user's overall interactions with the ice cream by reducing interaction time and effort.

Embodiments of the mix-in tool of this disclosure may include one or more of the following, in any suitable combination.

In some embodiments, a mix-in tool for use with processed food includes a handle and a shaft having a proximal end, a distal end, and a longitudinal axis extending therebetween. The proximal end is coupled to the handle. A first wing member has a first end coupled to a first side of the shaft. The first end of the first wing member extends between the proximal and distal ends of the shaft. A second wing member has a first end coupled to a second side of the shaft opposite the first side. The first end of the second wing member extends between the proximal and distal ends of the shaft.

In further embodiments, the handle includes a first concave surface and a second concave surface. The first and second concave surfaces define a cavity between ends of the first and second concave surfaces configured to hold ingredients. In embodiments, the first wing member defines a first concave surface extending between the first end and a second end of the first wing member. In embodiments, the second wing member defines a second concave surface extending between the first end and a second end of the second wing member. In embodiments, the first concave surface and the second concave surface define a helical profile of the first and second wing members extending between the second end of the first wing member and the second end of the second wing member on opposite sides of the shaft. In embodiments, the helical profile is configured to displace processed food and form a cavity in the processed food when the user inserts the shaft into the processed food and rotates the handle. In embodiments, the second ends of the first and second wing members are configured for scraping the processed food from a surface. In embodiments, the surface is an interior surface of a vessel. In embodiments, the processed food is ice cream. In embodiments, the handle is contoured to fit within a closed grasp of a user's hand.

In embodiments, a method of creating a cavity in processed food of this disclosure includes inserting a shaft of a mix-in tool into the processed food. The mix-in tool further includes a handle. The shaft has a proximal end, a distal end, and a longitudinal axis extending therebetween. The proximal end couples to the handle. A first wing member has a first end coupled to a first side of the shaft. The first end of the first wing member extends between the proximal and distal ends of the shaft. A second wing member has a first end coupled to a second side of the shaft opposite the first side. The first end of the second wing member extends between the proximal and distal ends of the shaft. The method also includes rotating the handle, whereby a helical profile formed by the first and second wing members forms the cavity by displacing the processed food.

In further embodiments, a respective second end of the first and second wing members is configured for scraping the processed food from an interior surface of a vessel. In embodiments, the first wing member defines a first concave surface extending between the first end and the second end of the first wing member. In embodiments, the second wing member defines a second concave surface extending between the first end and the second end of the second wing member. In embodiments, the first concave surface and the second concave surface define the helical profile formed by the first and second wing members extending between the second end of the first wing member and the second end of the second wing member on opposite sides of the shaft. In embodiments, the processed food is ice cream. In embodiments, the handle includes a first concave surface and a second concave surface. The first and second concave surfaces define a cavity between ends of the first and second concave surfaces configured to hold ingredients. In embodiments, the handle is contoured to fit within a closed grasp of a user's hand.

A reading of the following detailed description and a review of the associated drawings will make apparent the advantages of these and other features. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIGS. 1A and 1B are perspective views of a mix-in tool according to some embodiments of this disclosure;

FIG. 1C is a detailed view of the distal end of the mix-in tool of FIGS. 1A and 1B according to some embodiments;

FIGS. 2A-D are additional views of the mix-in tool of FIGS. 1A and 1B according to some embodiments, including a side view (FIG. 2A); a front, plan view (FIG. 2B); a perspective view (FIG. 2C); and a bottom view (FIG. 2D).

FIGS. 3A and 3B show a method of creating a central cavity in ice cream using the mix-in tool of FIGS. 1A and 1B according to some embodiments;

FIGS. 4A and 4B show methods of using the flat-edged sides of the mix-in tool of FIGS. 1A and 1B according to some embodiments; and

FIG. 5 shows the mix-in-tool of FIGS. 1A and 1B stored on a housing of a micro puree machine.

### DETAILED DESCRIPTION

The following disclosure provides a simple and easy-to-use tool which gives the user the ability to repeatably create a central cavity in partially processed ice cream to gently mix in ingredients before additional processing.

In the following description, like components have the same reference numerals, regardless of different illustrated embodiments. To illustrate embodiments clearly and concisely, the drawings may not necessarily reflect appropriate scale and may have certain features shown in somewhat schematic form. The disclosure may describe and/or illustrate features in one embodiment, and in the same way or in a similar way in one or more other embodiments, and/or combined with or instead of the features of the other embodiments.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts.

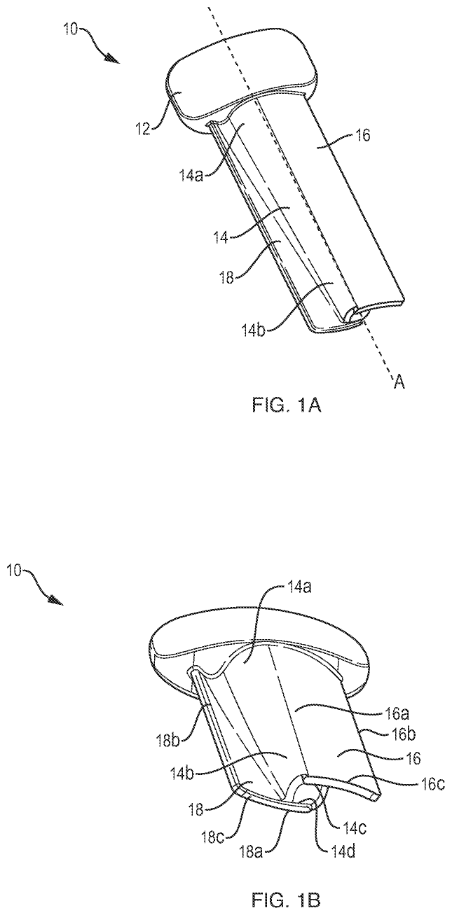

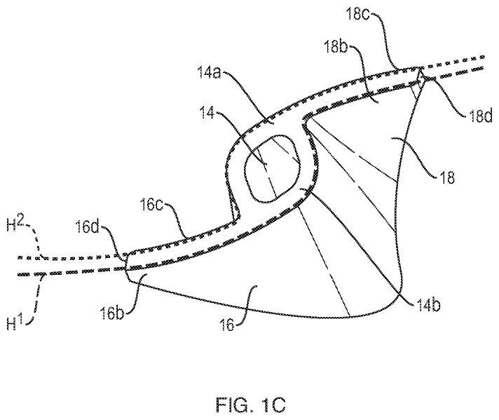

FIG. 1A shows a perspective view of a mix-in tool 10 according to some embodiments of this disclosure. A user can use the mix-in tool 10 for gently adding ingredients to partially processed ice cream. However, the disclosure also contemplates that a user can use the mix-in tool 10 to add ingredients to other types of semi-solid foods, such as icing or mousses. Some embodiments of the mix-in tool 10 may generally comprise a handle 12 and a central shaft 14 extending from the handle 10. The shaft 14 may have a proximal end 14a coupled to the handle 10, a distal end 14b remote from the handle, and a longitudinal axis A extending therebetween. The mix-in tool 10 may further comprise a first wing member 16 and a second wing member 18 coupled to the shaft 14. Embodiments of the handle 12, the shaft 14, and the wing members 18 may comprise metals, hard rubbers, hard or soft plastics, and/or other suitable materials. The disclosure also contemplates that the handle 12 includes an opening (not shown) in communication with a cannulation defined by the shaft 14 for introducing the ingredients into the ice cream.

FIG. 1B illustrates further details of the attachment of the first and second wing members 16, 18 to the shaft 14. The first wing member 16 may have a first end 16a coupled to a first side 14c of the shaft 14. The first end 16a of the first wing member 16 may extend between the proximal end 14a and the distal end 14b of the shaft 14. A second wing member 18 may have a first end 18a coupled to a second side 14d of the shaft 14 opposite the first side 14c. The first end 18a of the second wing member 18 may extend between the proximal end 14a and the distal end 14b of the shaft 14. The first wing member 16 may further define a concave surface 16c extending between the first end 16a and a second end 16b opposite the first end 16a. Similarly, the second wing member 18 may define a concave 18c surface extending between the first end 18a and a second end 18b opposite the first end 18a.

As shown in FIG. 1C, the concave surfaces 16c, 18c of the wing members 16, 18 may cause the first and second wing members 16, 18 to form a helical profile along lines H1 and H2 extending between the second end 16b of the first wing member 16 and the second end 18b of the second wing member 18 on both the first side 14a and the second side 14b of the shaft 14. In embodiments, the second ends 16b, 18b of the first and second wing members 16, 18 may also define spatula-like, flat-edged sides 16c, 18c for scraping the ice cream from a surface, such as an ice cream vessel.

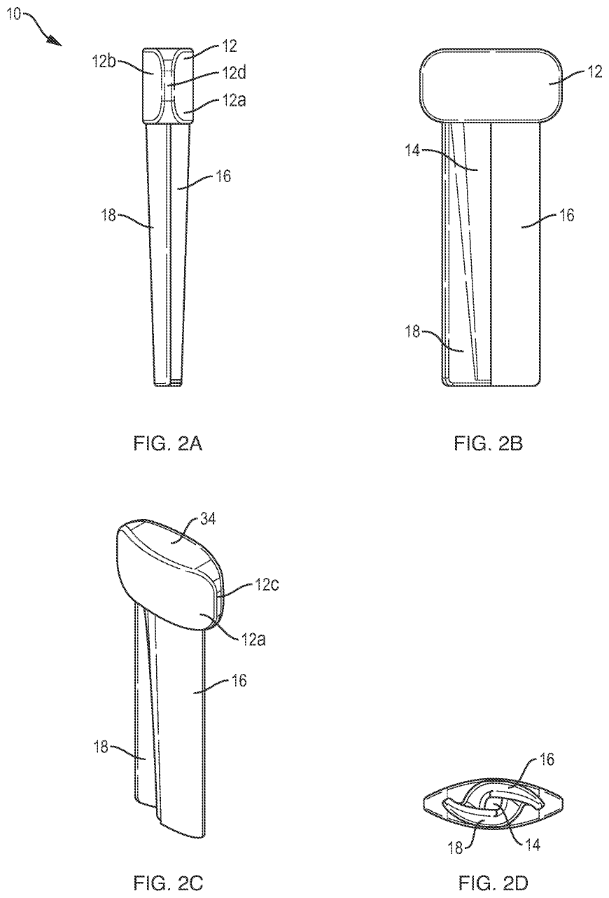

FIGS. 2A-D show additional views of the mix-in tool 10, including the handle 12, the shaft 14 and the wing members 16, 18. In particular, FIG. 2A shows an embodiment of the mix-in tool 10 in a side view; FIG. 2B shows an embodiment of the mix-in tool 10 in a front, plan view; FIG. 2C shows an embodiment of the mix-in tool 10 in a perspective view; and FIG. 2D shows an embodiment of the mix-in tool 10 in a bottom view. As shown in FIGS. 2A-D, the handle 12 may include a first surface 12a and a surface 12b opposite the first surface 12a. The first and second surfaces 12a,b of the handle 12 may have a curved profile such that the first and second surfaces 12a,b meet at a first end 12c and a second end 12d of the handle 12. As such, the handle 12 may be narrowly contoured to fit within a closed grasp of a user's hand. The first and second surfaces 12a,b furthermore may define a cavity 34 between the first and second ends 12c,d of the handle 12 for holding the ingredients to be mixed into the ice cream.

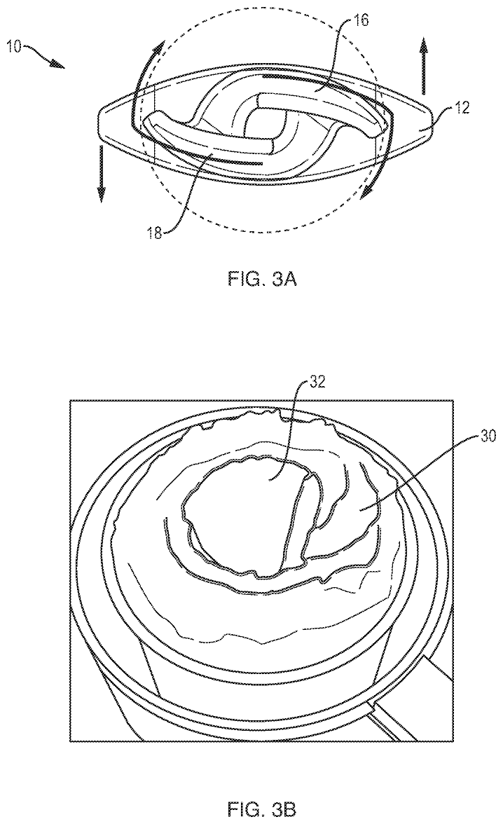

FIGS. 3A and 3B illustrate a method of creating a central cavity 32 in ice cream 30 or other food using the mix-in tool 10 according to some embodiments. As shown in FIG. 3A, when inserted into the ice cream 30, the helical profile of the wing members 16, 18 cause displacement of the ice cream 30 when the user rotates the handle 12 of the mix-in tool 10. This causes formation of the cavity 32 in the ice cream 30 whereby the user can add ingredients to the cavity 32 before further processing of the ice cream 30.

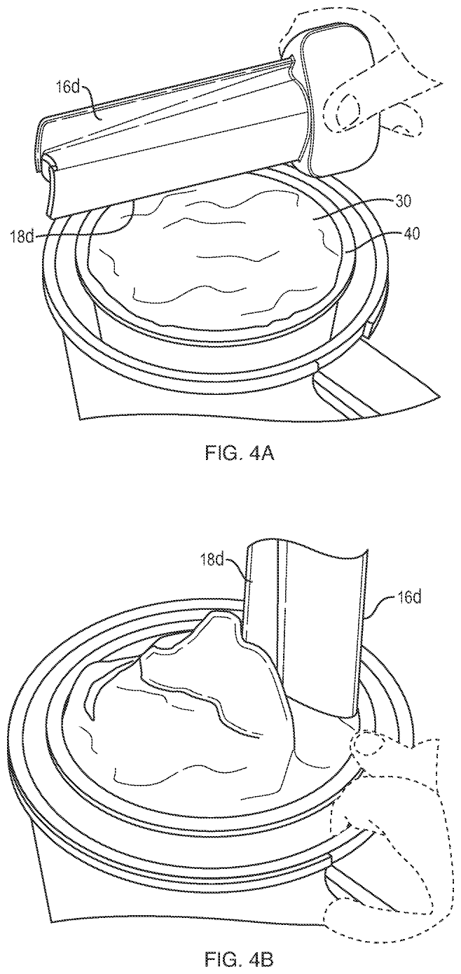

FIGS. 4A and 4B illustrate methods of using the flat-edged sides 16d, 18d of the mix-in tool 10 according to some embodiments. As shown in FIG. 4A, the user may use the flat-edged sides 16d, 18d to level a surface of the ice cream 30 relative to the top of a vessel 40. As shown in FIG. 4B, the user may also use the flat-edged sides 16c, 18c to scrape the interior surfaces of the vessel 40.

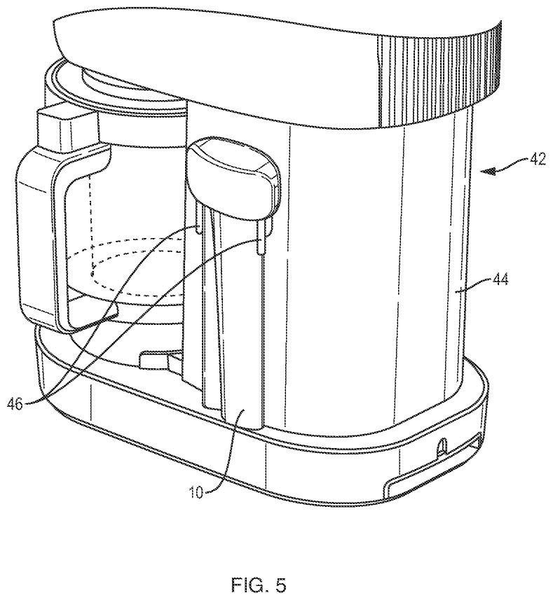

FIG. 5 illustrates the mix-in tool 10 stored on a housing 44 of a micro puree machine 42, such as an ice cream maker. A user can store the mix-in tool 10 on the machine 42 by means of clips 46 as shown, or by other suitable means, such as magnets.

While the disclosure particularly shows and describes preferred embodiments, those skilled in the art will understand that various changes in form and details may exist without departing from the spirit and scope of the present application as defined by the appended claims. The scope of this present application intends to cover such variations. As such, the foregoing description of embodiments of the present application does not intend to limit the full scope conveyed by the appended claims.

We claim:

1. A mix-in tool for use with processed food comprising:
a handle;
a shaft having a proximal end, a distal end, and a longitudinal axis extending therebetween, the proximal end coupled to the handle;
a first wing member having a first end coupled to a first side of the shaft, the first end of the first wing member extending between the proximal and distal ends of the shaft; and
a second wing member having a first end coupled to a second side of the shaft opposite the first side, the first end of the second wing member extending between the proximal and distal ends of the shaft.

2. The mix-in-tool of claim 1, wherein the handle includes a first concave surface and a second concave surface, the first and second concave surfaces defining a cavity between ends of the first and second concave surfaces configured to hold ingredients.

3. The mix-in tool of claim 1, wherein the first wing member defines a first concave surface extending between the first end and a second end of the first wing member.

4. The mix-in tool of claim 3, wherein the second wing member defines a second concave surface extending between the first end and a second end of the second wing member.

5. The mix-in tool of claim 4, wherein the first concave surface and the second concave surface define a helical profile of the first and second wing members extending between the second end of the first wing member and the second end of the second wing member on opposite sides of the shaft.

6. The mix-in tool of claim 5, wherein the helical profile is configured to displace processed food and form a cavity in the processed food when the user inserts the shaft into the processed food and rotates the handle.

7. The mix-in tool of claim 4, wherein the second ends of the first and second wing members are configured for scraping the processed food from a surface.

8. The mix-in tool of claim 7, wherein the surface is an interior surface of a vessel.

9. The mix-in tool of claim 1, wherein the processed food is ice cream.

10. The mix-in tool of claim 1, wherein the handle is contoured to fit within a closed grasp of a user's hand.

11. A method of creating a cavity in processed food, the method comprising:
inserting a shaft of a mix-in tool into the processed food, the mix-in tool further comprising:
a handle;
the shaft having a proximal end, a distal end, and a longitudinal axis extending therebetween, the proximal end coupled to the handle;
a first wing member having a first end coupled to a first side of the shaft, the first end of the first wing member extending between the proximal and distal ends of the shaft; and
a second wing member having a first end coupled to a second side of the shaft opposite the first side, the first end of the second wing member extending between the proximal and distal ends of the shaft; and
rotating the handle, whereby a helical profile formed by the first and second wing members forms the cavity by displacing the processed food.

12. The method of claim 11, wherein a respective second end of the first and second wing members is configured for scraping the processed food from an interior surface of a vessel.

13. The method of claim 11, wherein the first wing member defines a first concave surface extending between the first end and the second end of the first wing member.

14. The method of claim 13, wherein the second wing member defines a second concave surface extending between the first end and the second end of the second wing member.

15. The method of claim 14, wherein the first concave surface and the second concave surface define the helical profile formed by the first and second wing members extending between the second end of the first wing member and the second end of the second wing member on opposite sides of the shaft.

16. The method of claim 11, wherein the processed food is ice cream.

17. The method of claim 11, wherein the handle includes a first concave surface and a second concave surface, the first and second concave surfaces defining a cavity between ends of the first and second concave surfaces configured to hold ingredients.

18. The method of claim 11, wherein the handle is contoured to fit within a closed grasp of a user's hand.
